(19) United States
(12) Patent Application Publication
(10) Pub. No.: US 2006/0032944 A1
(43) Pub. Date: Feb. 16, 2006

(54) Method and apparatus for surface treatment

(76) Inventors: James Russell Hornsby, St. Louis, MO (US); Marcellus Rambo Benson, Chesterfield, MO (US); James Augustus Keefe III, O'Fallon, MO (US); Joseph Lee McGowan, St. Charles, MO (US)

Correspondence Address: DORSEY & WHITNEY LLP;INTELLECTUAL PROPERTY DEPARTMENT, 50 SOUTH SIXTH STREET, MINNEAPOLIS, MN, 55402-1498, US

(21) Appl. No.: 11/199,295

(22) Filed: Aug. 8, 2005

Related U.S. Application Data
(60) Provisional application No. 60/599,991, filed on Aug. 9, 2004.

(51) Int. Cl. A62C 13/62; A62C 11/00; F23D 14/28; B05B 1/00; A62C 13/66

(52) U.S. Cl. 239/333; 239/302; 239/337; 239/600

(57) ABSTRACT

A surface treatment device, including a body having a nozzle, a cartridge configured to be removeably attachable to the body, wherein the cartridge can receive treatment fluid, a spray pump associated with the body, wherein the spray pump can spray the treatment material through the nozzle onto a target surface, and a contact component associated with the body, the contact component configured to contact the target surface.

### CROSS-REFERENCE TO RELATED APPLICATIONS(S)

This application claims priority to U.S. provisional patent application Ser. No. 60/599,991, filed Aug. 9, 2004, which is incorporated herein by reference in its entirety.

### BACKGROUND

The present invention relates to devices, apparatus and equipment, and methods for treating a surface, including such devices, apparatus and equipment, and methods for dispensing a substance useful for cleaning and/or for treating surfaces. In one embodiment, the present invention relates to an apparatus having a pump and spray system for delivering a cleaning substance to a surface, and a contact component and material for cleaning a surface.

Hand operated sprayers are often mounted on containers of household liquids such as window and bathroom cleaners or liquid coating compounds for polishing or protecting surfaces. A liquid is dispensed from the hand-operated sprayer by repeatedly squeezing a lever on the sprayer. Once the liquid is applied to the surface, a user needs a cleaning cloth or pad, for example, in order for the liquid to be wiped off for cleaning, or rubbed in for polishing and treating. Using both the hand-operated sprayer and the cleaning cloth or pad can be cumbersome.

Hand-operated sprayers may also need to be used over large surfaces, and may need to be pumped several times. This may result in user fatigue. Consequently, powered sprayers have been previously developed to replace the hand-operated sprayers.

These previous powered sprayers suffer from several drawbacks. First, they often cannot be mounted on an off-the-shelf container of household liquid, instead relying on a special reservoir that must be refilled by the user. This can be messy and/or inconvenient for a user. With respect to aerosol can propelled solutions, the negative environmental aspects are well-known. Also, a steel container containing a high pressure is inherently dangerous and expensive. Further, performance is not consistent, i.e., propellant force is stronger initially and weakens as propellant is exhausted.

Second, the previous powered sprayers have spray heads or housings that are substantially larger and heavier than the standard hand operated sprayers. As a result, the previous powered sprayers tend to be top heavy and unwieldy. They tend to be expensive in comparison to non-powered sprayers and, for at least these reasons, are not optimally marketable.

There is a need in the art for a cleaning tool combined with a sprayer that relieves the need for the user to have a cleaning cloth or pad separate from a sprayer. Furthermore, there is a need in the art for a cleaning tool having a power sprayer that relieves the need to repeatedly squeeze the lever on the sprayer, can be attached to off-the-shelf containers, is relatively ergonomic and easy to handle, and that can deliver the contents of the container from relatively safe distances.

### SUMMARY

The present invention, in one embodiment, provides a surface treatment apparatus suitable for many uses including for home and kitchen, countertop, sink and bath cleaning.

In one embodiment, the apparatus is cartridge-based and uses no-leak replacement cleaning fluid cartridges that snap into the apparatus.

In one embodiment, the apparatus has a body having a nozzle, a replaceable cartridge, a spray pump, and a surface contacting component. The cartridge is configured to be removeably attachable to the body and to receive a treatment substance or fluid. In one aspect of the invention, the spray pump is associated with the body and is configured to spray the treatment fluid or dispense the treatment substance through the nozzle onto a target surface.

In one embodiment, the surface contact component is replaceable. For example, the contact component may be an interchangeable pad and/or may be attached or connected to the body of the surface treatment apparatus using a peel and stick feature or other suitable structure or method. In accordance with a further embodiment, the contact component may include a washable pad such as a micro-fiber fleece pad. Furthermore, the surface contact component, consistent with an embodiment of the invention, may be shaped based on the shape of the surface to be treated. For example, the surface contact component may be shaped for bathtubs and have rounded and/or rolled edges.

Some embodiments of the present invention may incorporate and motor or motors for powering the pump, and/or one or more vibration motors for causing a portion of the apparatus to vibrate. Either or both of the motorized spray pump and vibration motor may be operated using one or more suitable switches, in accordance with embodiments of the invention, wherein the switches, allow for simple one touch activation of the spray pump motor and/or the vibration motor. This enables one-handed power spraying and/or wiping.

In one embodiment, the nozzle may be pivotally attached to the body, and may deliver sprays, streams, and foams, for example. In another embodiment, the surface treatment apparatus dispenses fluid only during pump actuation in order to prevent nozzle-drool.

Further advantages and/or features of the present invention are that it may be made to be resistant to chemicals, it may include a body protection component such as a rubber bumper coupled to the body, the replaceable cartridge may be secured to the body using one or more connecting and/or locking components, and the apparatus may be suitable ergonomically shaped for comfortable handheld use and for effective cleaning.

The present invention encompasses a method of treating an object or surface involving a handheld surface treatment apparatus having a body that includes a nozzle, a replaceable cartridge that is removeably attachable to the body and configured to receive treatment fluid, a pump associated with the body and capable of spraying the treatment fluid through the nozzle onto a target surface, and a replaceable contact component associated with the body, the contact component configured to contact the target surface, wherein the method comprises providing the apparatus, applying it to a surface to be treated and, in some embodiments, actuating the pump to dispense treatment fluid onto the surface.

In another embodiment, the present invention is a cleaning device comprising a replaceable cartridge. The cartridge has a cartridge body configured to mate with the cleaning device, a liquid container defined by the cartridge body, and an opening defined in the liquid container, the opening configured to be in fluid communication with a nozzle of the cleaning device. In one embodiment, the replaceable cartridge includes one or more securing components such as a suitable lock, e.g., a snap lock, a detent arrangement, a clasp, etc., for securably attaching it to the body of the cleaning device.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIGS. 1A and 1B depict a side view and a top view, respectively, of a treatment device according to one embodiment of the present invention.

FIGS. 2A and 2B depict a top view and a side view, respectively, of a treatment device having a replaceable cartridge, according to one embodiment of the present invention.

FIGS. 3A and 3B depict a top view and a side view, respectively, of a treatment device having a replaceable cartridge, according to one embodiment of the present invention.

FIGS. 4A and 4B depict a top view and a side view, respectively, of a treatment device having a replaceable cartridge, according to an alternative embodiment of the present invention.

### DETAILED DESCRIPTION

The present invention relates to a surface treatment device. The device allows for simple and effective surface treatment by providing both a spraying system and contact system in the same apparatus. Further, the device according to one embodiment allows for further ease and effectiveness by providing a vibrating system that enhances the surface treating action.

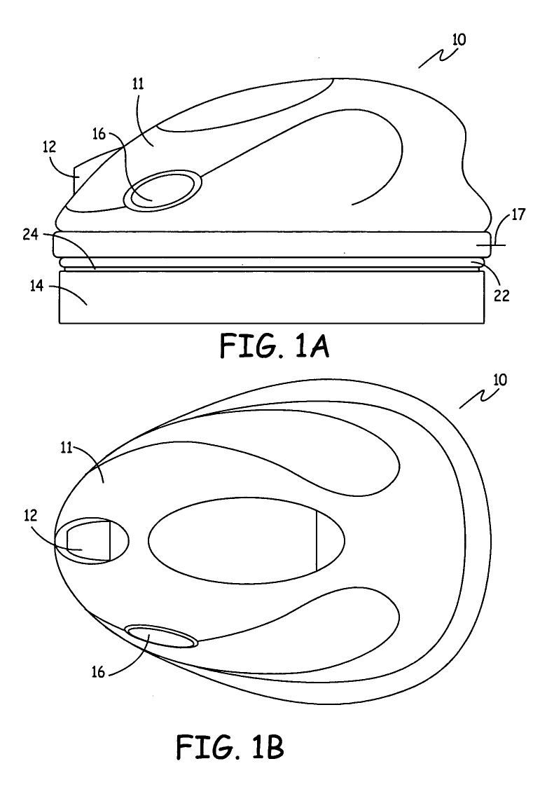

FIGS. 1A and 1B depict a side view and a top view, respectively, of a treatment device 10, according to one embodiment of the present invention. The treatment device 10 has a body 11, a nozzle component 12, a detachable contact component 14, and an actuation button 16. In one aspect of the invention, actuation of the actuation button 16 causes treatment fluid to be sprayed from the nozzle component 12. According to one embodiment, the device is ergonomically shaped as shown to allow for easy gripping and use. According to embodiments, the body 11 may include a body protection component 17, such as a rubber bumper, for protecting both the treatment device and objects that may be hit or brushed against during movement of the treatment device. In some embodiments, a suitable handle or body extension may be connectable or deployable for extending the reach of the device. One example of a suitable handle is disclosed in U.S. provisional patent application Ser. No. 60/600,507, filed Aug. 9, 2004, the contents of which are incorporated herein by reference.

The detachable contact component 14, in one aspect of the present invention, has a mating surface and/or structure 24 that detachably connects or mates with mating surface (or structure) 22 on the device 10, thereby allowing the contact component 14 to be removeably attached to the device 10. In one embodiment, the contact component 14 is made of a microfiber material. Alternatively, the contact component 14 is made of a sponge material, a foam material, a pad material, or any other known material for surface treatment of any known kind. In another embodiment the contact component 14 has a peel and stick mating surface 24. In some embodiments, the entire device may be designed to be disposable and, therefore, the contact component may be permanently or non-removably part of or integrated with the device. In embodiments, in which the contact component is intended to be replaceable, any suitable connective, mounting or attaching method or structure may be used, e.g., complementary coupling structures, snap fittings, an elastic skirt, contact adhesives, etc. In some embodiments, the contact component and the surface 22 of the device may be integrated as the replaceable or permanent surface contacting portion of the device.

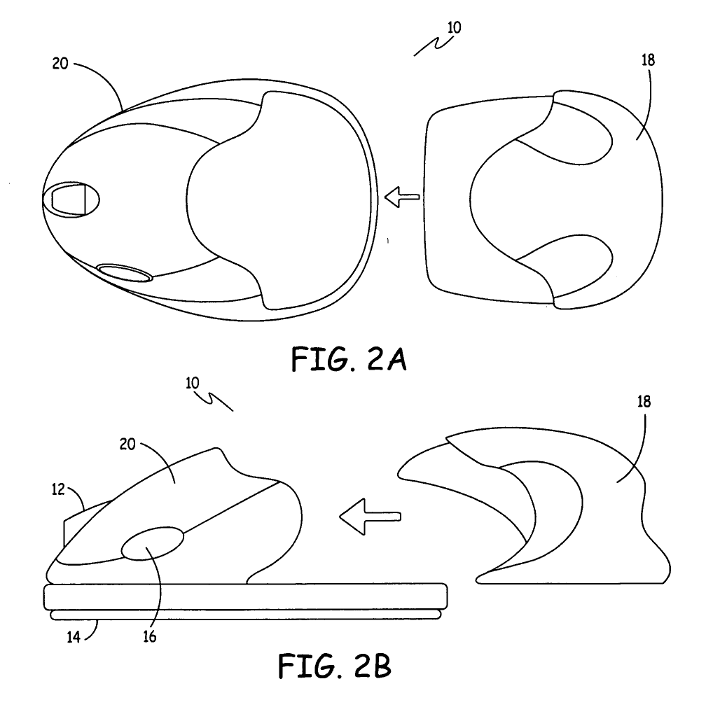

According to one embodiment, the treatment device of the present invention has a replaceable cartridge that contains the treatment fluid to be sprayed through the nozzle component. FIGS. 2A and 2B depict a top view and a side view, respectively, of a treatment device 10 having a replaceable cartridge 18, according to one embodiment of the present invention. The cartridge 18 and the base component 20 are shaped to mate with each other as shown by the arrows. In one example, the replaceable cartridge 18 snaps into the base component, where the replaceable cartridge 18 is configured minimize or prevent leakage.

In use, the device 10 can be used for treatment of any surface. According to one embodiment, the actuation button 16 is actuated, thereby causing treatment fluid to be sprayed from the nozzle component 12 onto a target surface. Once the fluid has been sprayed onto the target surface, the detachable contact component 14 is placed in contact with the target surface and moved around on the target surface. When all the fluid in a particular cartridge 18 has been used up and the cartridge 18 is substantially empty, the cartridge 18 can be un-mated or removed from the base component 20 and replaced with another, “fresh” cartridge 18 containing fluid. Further, when a contact component 14 is worn or it is desirable to replace the contact component 14 for any reason, the contact component 14 can be removed from the device 10 by separating the mating surface 22 (see FIG. 1A) of the device 10 from the mating surface 24 (see FIG. 1A) of the contact component 14, and a new or different contact component 14 can be mated to the device 10.

According to one embodiment, the treatment fluid is a cleaning fluid that is sprayed on a surface and then the contact component 14 is placed in contact with the surface to provide a scrubbing, wiping, or any other known type of action. For example, the treatment fluid could be a cleaning substance such as glass cleaner, surface cleaner, household disinfectant, or the like. In a further example, the treatment fluid could be any other type of substance, such as a herbicide, fungicide, or any other known liquid cleaning substance. Alternatively, the treatment fluid is a polishing fluid that is sprayed on the surface and then the contact component 14 is placed in contact with the surface to provide a polishing, buffing, or any other known type of action relating to polishing a surface. The treatment fluid in this embodiment can be any kind of liquid polishing fluid, surface protectant fluid or any other known type of fluid for improving or protecting the appearance of a surface. In a further alternative, the treatment fluid is any known fluid that is sprayed on the target surface and then the contact component 14 is placed in contact with the surface for any known purpose. It is to be understood that any materials used for forming the components of the present invention can be selected on the basis of compatibility with the material to be applied, sprayed, or dispensed.

The nozzle component 12, according to one embodiment, is a spray-only nozzle as known in the art, with three spraying options of fine spray, medium spray, or coarse spray. Alternatively, the nozzle component 12 is a foaming nozzle having air intakes that allow air to be introduced into the stream of the spray. According to one embodiment, the foaming nozzle includes a spray-through screen that creates turbulence to mix air and fluid for foaming action. In a further alternative, the nozzle component 12 is a screw-type nozzle with a full range of stream and spray patterns. The screw-type nozzle, in one aspect of the invention, can have a removable cap for rinsing.

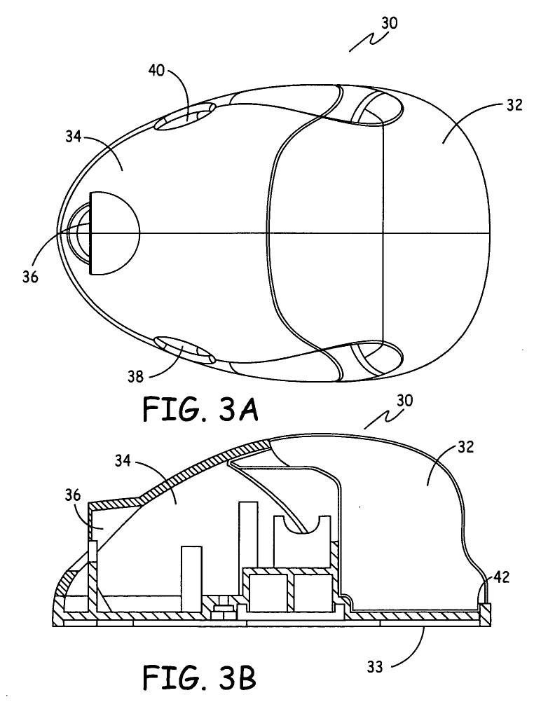

FIGS. 3A and 3B depict a top view and a side view, respectively, of a treatment device 30 having a replaceable cartridge 32, according to one embodiment of the present invention. The cartridge 32 is mated to the base component 34. The device 30 also has nozzle component 36, a first actuation button 38 and a second actuation button 40. According to one embodiment, the first and second actuation buttons 38, 40 both can be used to actuate the spraying of treatment liquid from the nozzle component 36. Alternatively, one of the buttons 38, 40 can be used to actuate spraying liquid from the nozzle 36 and the other can be used to activate a vibration motor (not shown) within the device 30. The vibration motor, according to one embodiment, creates a vibrating action that enhances the treatment action of the treatment liquid and the contact component (not shown) that can be attached to the mating surface 33. According to one embodiment, either or both of the actuation buttons 38, 40 can be switches or any other known type of actuation components.

The replaceable cartridge 32 in FIG. 3B is, according to one embodiment, removeably secured to the base component 34 using a snap lock component 42. Alternatively, any known fastening component can be used to removeably secure the cartridge 32 to the base component 34.

The vibration motor (not shown), according to one embodiment, is any known motor for creating a vibrating action that causes the entire device to vibrate.

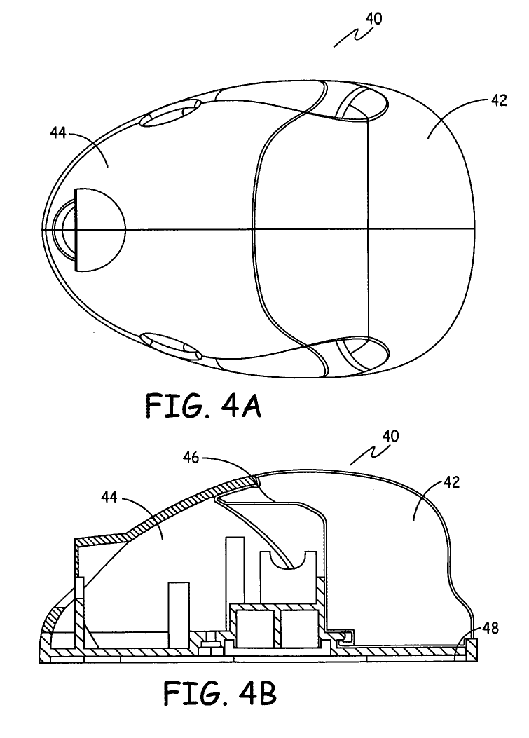

FIGS. 4A and 4B depict a top view and a side view, respectively, of a treatment device 40 having a replaceable cartridge 42, according to an alternative embodiment of the present invention. The cartridge 42 is mated to the base component 44 and removeably secured to the base component 44 using snap lock components 46, 48. Alternatively, any known fastening component can be used to removeably secure the cartridge 42 to the base component 44.

In one embodiment, the apparatus of the present invention has a motor for powering a spray pump used to spray of fluid from the nozzle. A spray pump motor may, according to one example, operate at 8,000 RPM. Alternatively, the motor is any known motor for powering a spray pump.

The spray pump, in one aspect of the present invention, is any known spray pump for spraying fluid through a nozzle. In one embodiment, the spray pump may be a piston pump. In another embodiment, the spray pump in the device of the present invention can be any spray pump disclosed in U.S. patent application Ser. No. 10/863,817, filed on Jun. 8, 2004, which is hereby incorporated by reference herein in its entirety. In a further example, the spray pump may be pivotally attached to the body allowing multi-directional spray. In additional embodiments, the pump is any suitable known pump, such as a peristaltic pump, etc.

In one aspect of the present invention, the apparatus also includes an anti-drool system that prevents mid-stroke nozzle drool. The system can be a secondary motor circuit activated by a contact switch on a gear box. Alternatively, the system can be any such known system.

The apparatus according to one embodiment also has a safety lock associated with the device. The lock is configured to prevent accidental spraying.

Appendix A has been attached herein to describe some non-limiting embodiments of the present invention.

Although the present invention has been described with reference to preferred embodiments, persons skilled in the art will recognize that changes may be made in form and detail without departing from the spirit and scope of the invention.

What is claimed is:

1. A surface treatment apparatus comprising:
a body comprising a nozzle;
a cartridge configured to be removeably attachable to the body, the replaceable cartridge configured to receive a treatment fluid;
a pump associated with the body, the pump configured to move the treatment fluid through the nozzle onto a target surface; and
a contact component associated with the body, the contact component configured to contact the target surface.

2. The apparatus of claim 1, wherein the pump is motorized.

3. The apparatus of claim 1, wherein the pump is pivotally attached to the body.

4. The apparatus of claim 1 further comprising at least one button coupled to the body configured to enable the pump.

5. The apparatus of claim 1, wherein the contact component is replaceable.

6. The apparatus of claim 1, wherein the contact component is shaped based on a shape of the target surface.

7. The apparatus of claim 1 further comprising at least one vibration motor configured to cause a portion of the apparatus to vibrate.

8. The apparatus of claim 7 further comprising at least one button coupled to the body configured to start the vibration motor.

9. The apparatus of claim 1, wherein the nozzle is pivotally attached to the body and configured to deliver a plurality of spray types.

10. The apparatus of claim 1, wherein the nozzle comprises a spray nozzle.

11. The apparatus of claim 1, wherein the nozzle comprises a stream and spray nozzle.

12. The apparatus of claim 1, wherein the nozzle comprises a foaming nozzle.

13. The apparatus of claim 1, wherein the surface treatment apparatus is configured to dispense liquid during actuation of the pump and to retain liquid when the pump is not actuated.

14. The apparatus of claim 1, wherein the body comprises a body protection component.

15. The apparatus of claim 1, wherein the body comprises at least one securing component for securing the replaceable cartridge to the body.

16. The apparatus of claim 1, wherein the surface treatment apparatus is ergonomically shaped for handheld use.

17. A method of treating an object or surface, the method comprising:
providing a handheld surface treatment apparatus comprising:
a body comprising a nozzle;
a cartridge configured to be removeably attachable to the body, the replaceable cartridge configured to receive treatment fluid;
a pump associated with the body, the pump configured to move the treatment fluid through the nozzle onto a target surface; and
a contact component associated with the body, the contact component configured to contact the target surface,
actuating the pump to dispense the treatment fluid; and
moving the contact component into contact with the target surface.

18. The apparatus of claim 17 further comprising moving the handheld surface treatment apparatus relative to the target surface while the apparatus is in contact with the target surface.

19. A replaceable cartridge comprising:
a cartridge body configured to mate with a surface treatment apparatus;
a liquid container defined by the cartridge body; and
an opening defined in the liquid container, the opening configured to be in fluid communication with a nozzle of the surface treatment apparatus.

20. The replaceable cartridge of claim 19 further comprising at least one securing component for replaceably securing the replaceable cartridge to the surface treatment apparatus.
